(19) United States
(12) Patent Application Publication
(10) Pub. No.: US 2007/0076610 A1
(43) Pub. Date: Apr. 5, 2007

(54) Techniques using channel utilization metrics to avoid network under utilization for mesh flow control

(76) Inventors: Liuyang Lily Yang, Portland, OR (US); Bahareh Sadeghi, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/240,140

(22) Filed: Sep. 30, 2005

(51) Int. Cl. H04J 1/16

(52) U.S. Cl. 370/235

(57) ABSTRACT

An embodiment of the present invention provides a method, comprising using a flow control technique in a distributed communication wireless network to notify traffic sources of transmission rates which would be appropriate for a given network state and to detect congestion and under utilization in the wireless network, and increasing the traffic source's data rate upon detection of under utilization in the wireless network.

### BACKGROUND

Wireless communications, including wireless networks, have become pervasive throughout society. Improvements in wireless communications are vital to increase their reliability and speed. Mesh networks are an example of wireless networks that may provide distributed communication and are in there infancy in development.

The purpose of a flow control mechanism in wireless communications may be to adjust the transmission rate of a source to ensure efficient utilization of the resource in the network. While flow control is well studied in wired networks and there are multiple mechanisms developed to ensure that different flows share network resources in an efficient and fair manner, in wireless networks such a mechanism does not exist. The need for a congestion control mechanism is especially evident in mesh networks, where not only flows share a common resource, i.e., wireless channel, but also each packet traverses over multiple hops prior to reaching its destination. If a source keeps injecting packets into the network while, due to some congestion downstream, the packets are not being delivered to their final destination, this significantly reduces the throughput of the whole system as the scarce resource is being utilized to transmit packets which will be dropped eventually.

Thus, a strong need exists for techniques to regulate the traffic injection rate at the sources when congestion happens in the network. On the other hand, if such a congestion control mechanism exists that is capable to decrease the traffic injection rate into the network in the face of congestion, it also becomes necessary to have the ability to increase the traffic injection rate in the event that such congestion condition is removed, so that the network is fully utilized to meet the traffic demands.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 illustrates an example of a node's perception of time and its measurement window and channel busy and idle periods of one embodiment of the present invention;

FIG. 2 illustrates an example scenario with 3 nodes and 2 multi-hop flows (forward flow and reverse flow) of one embodiment of the present invention;

FIG. 3 illustrates the throughput of reverse flow over the two hops in the example shown in FIG. 2 in one embodiment of the present invention;

FIG. 4 illustrates the throughput of forward flow over the two hops in the example shown in FIG. 2 without use of channel busy time in one embodiment of the present invention; and

FIG. 5 illustrates the throughput of forward flow over the two hops in the example shown in FIG. 2 with the use of channel busy time in one embodiment of the present invention

It will be appreciated that for simplicity and clarity of illustration, elements illustrated in the figures have not necessarily been drawn to scale. For example, the dimensions of some of the elements are exaggerated relative to other elements for clarity. Further, where considered appropriate, reference numerals have been repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

An algorithm or process is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Embodiments of the present invention may include apparatuses for performing the operations herein. An apparatus may be specially constructed for the desired purposes, or it may comprise a general purpose computing device selectively activated or reconfigured by a program stored in the device. Such a program may be stored on a storage medium, such as, but not limited to, any type of disk including floppy disks, optical disks, compact disc read only memories (CD-ROMs), magnetic-optical disks, read-only memories (ROMs), random access memories (RAMs), electrically programmable read-only memories (EPROMs), electrically erasable and programmable read only memories (EEPROMs), magnetic or optical cards, or any other type of media suitable for storing electronic instructions, and capable of being coupled to a system bus for a computing device.

The processes and displays presented herein are not inherently related to any particular computing device or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the invention as described herein. In addition, it should be understood that operations, capabilities, and features described herein may be implemented with any combination of hardware (discrete or integrated circuits) and software.

Use of the terms “coupled” and “connected”, along with their derivatives, may be used. It should be understood that these terms are not intended as synonyms for each other. Rather, in particular embodiments, “connected” may be used to indicate that two or more elements are in direct physical or electrical contact with each other. “Coupled” my be used to indicated that two or more elements are in either direct or indirect (with other intervening elements between them) physical or electrical contact with each other, and/or that the two or more elements co-operate or interact with each other (e.g. as in a cause and effect relationship).

It should be understood that embodiments of the present invention may be used in a variety of applications. Although the present invention is not limited in this respect, the devices disclosed herein may be used in many apparatuses such as in the transmitters and receivers of a radio system. Radio systems intended to be included within the scope of the present invention include, by way of example only, cellular radiotelephone communication systems, satellite communication systems, two-way radio communication systems, one-way pagers, two-way pagers, personal communication systems (PCS), personal digital assistants (PDA's), wireless local area networks (WLAN), personal area networks (PAN, and the like), wireless wide are networks (WWAN) and Mesh networks.

Currently there is no flow control/congestion control mechanism being used in IEEE 802.11 networks—it is understood that the present invention is not limited to the IEEE 802.11 networks or any particular networks in general. All nodes just behave greedily and transmit as many packets as possible. While in single-hop networks this leads to maximized throughput, in mesh networks where packets traverse multiple-hops, this will result in inefficiency and waste of the valuable resource in an overloaded network to transmit packets which will be dropped before reaching their final destinations.

It is possible to provide a basic hop by hop flow control mechanism to detect and communicate congestion conditions at downstream nodes back to the upstream nodes so that upstream nodes can be properly rate limited. But techniques should also provide a mechanism to detect under-utilization when such congestion is removed in the network and so the network performance is not suboptimal when under-utilization occurs.

Some embodiment of the present invention provides mechanisms to use measurements of channel idle time as a metric to be used to detect under-utilization in the network as well as a mean to estimate the target transmission rate that can be handled by the network. Such a target rate may be used by the upstream nodes to limit their transmission rate to this upper bound and hence avoid severe congestion at the first place.

An embodiment of the present invention provides the utilization of existing channel busy measurements in wireless nodes and that each Mesh Point passively observes the channel busy time and uses that to decide whether its neighborhood is over or under-utilized. Further, an embodiment of the present invention allows having an idle threshold as a system parameter that may be adjusted in different networks based on the specific characteristics of the system.

In an embodiment of the present invention, a flow control mechanism may be used to notify the traffic sources of the transmission rates which would be appropriate for a given network state. This requires mechanisms to detect congestion as well as under utilization in the network. It is noted that under utilization may be caused by either removal of a source of congestion (over-utilization of a link) or addition of resources (change in channel quality or presence of new paths)—although the present invention is not limited to these reasons for under utilization.

An embodiment of the present invention provides using the measurement of channel idle time as a metric to be used to detect under-utilization in the network as well as a mean to estimate the target transmission rate that can be handled by the network. Such a target rate may be used by the upstream nodes to limit their transmission rate to an upper bound and hence avoid severe congestion in the first place.

A wireless channel is a resource which may be shared among nodes referred to in a contention region in mesh networks. In an embodiment of the present invention, when any node accesses the channel for transmission of a packet, the channel will be measured busy by all other nodes within interference range of that node for the duration of the packet transmission. As the load in the system increases, the percentage of the time that the channel is sensed busy also increases.

A node measures the channel busy and idle times in its contention region by use of a measurement window, Tₘₑₐₛᵤᵣₑₘₑₙₜ. Each node, if not transmitting, senses the channel regularly and is able to measure channel busy time, T_{busy}, over measurement window Tₘₑₐₛᵤᵣₑₘₑₙₜ. The more utilized the channel, the greater T_{busy}. The channel idle time, T_{idle}, is then Tₘₑₐₛᵤᵣₑₘₑₙₜ−T_{busy}. The channel is considered under-utilized if T_{idle}>T_{threshold}, where T_{threshold} is a pre-set threshold. The present invention is not limited to any particular threshold.

The present invention provides that the channel idle time is one effective way to estimate the channel utilization and hence may be utilized to compute the maximum transmission rate that would not over-load the network, although the present invention is not limited to only channel idle time as the only effective estimation of channel utilization.

A guideline in determining channel idle threshold may be the relation between the channel busy time and channel utilization and may depend on the underlying MAC protocol. For example, but not limited to, the Institute for Electronic and Electrical Engineers (IEEE) 802.11 DCF factors like whether RTS/CTS is on, or the specific NAV setting mechanism, as well as the operation rate of the network affect this relation. In an embodiment of the present invention and not limited to this example, for a single rate IEEE 802.11 operating in 2 Mbps with use of RTS/CTS, it has been demonstrated that a 100% utilized channel results in a T_{busy}, to Tₘₑₐₛᵤᵣₑₘₑₙₜ ratio of approximately 70%. The remaining 30% may be used for backoffs and other silent periods (including, but not limited to SIFS, DIFS, etc).

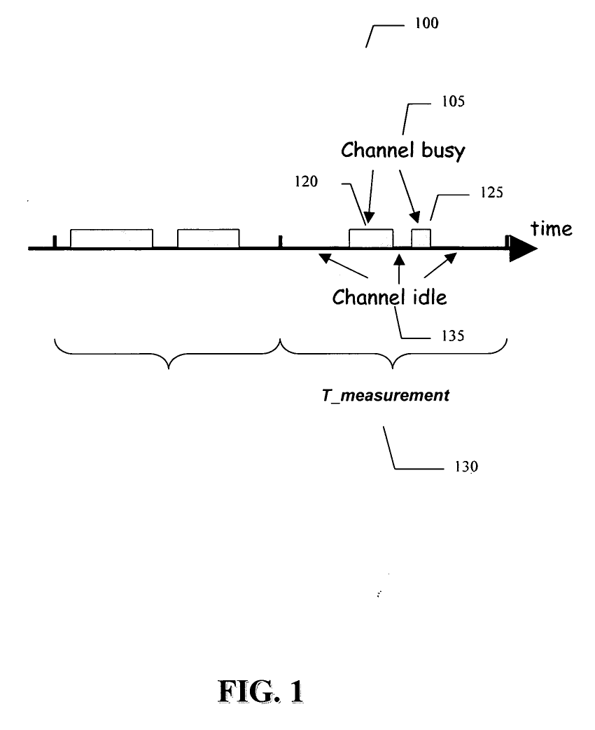

Turning now to the figures, FIG. 1 illustrates generally at 100 an example of a node's perception of time and its measurement window 130 which includes both channel busy time 105 (including blocks of time 120 and 125) and channel idle periods 135. It illustrates how each Mesh Point in the network can measure its own channel idle time as a metric to be used in congestion control to detect under-utilization and prevent congestion in the system.

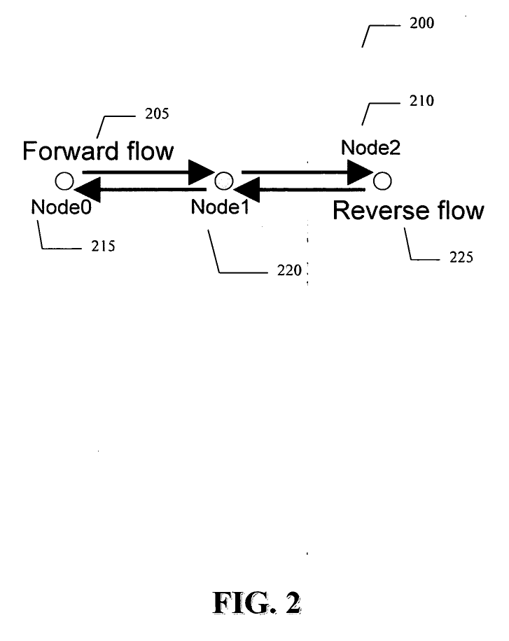

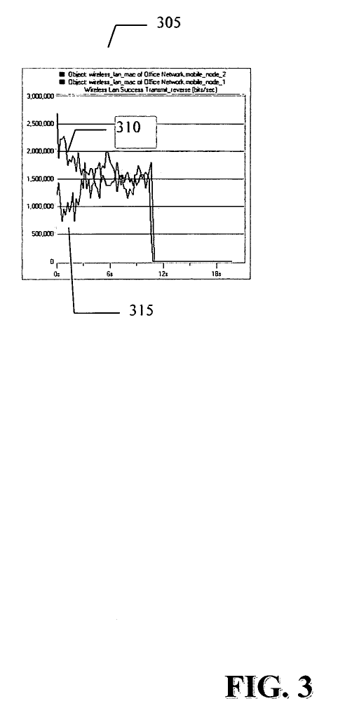

FIG. 2, at 200, depicts a scenario where the network consists of 3 nodes, all within one contention region. There are 2 flows 205 and 225 in the network, one between node 0 (215) and node 2 (210) (called forward flow 205), and the other one on the opposite direction 225 from node 2 (210) to node 0 (215) via node 1 (220) (called reverse flow 225). Both flows are fully backlogged. Use of flow control in the network ensures that the sources will only inject as many packets that the downstream nodes can manage forwarding to the destination. And hence as graphically depicted in FIG. 3, generally at 305, the throughput of reverse flow over both hops converges to approximately 1.5 Mbps (the same is true for the forward flow) due to congestion control. The effective throughput received by Node 1 is illustrated at 315 and Node 2 at 310. The reverse flow stops at time t=10s.

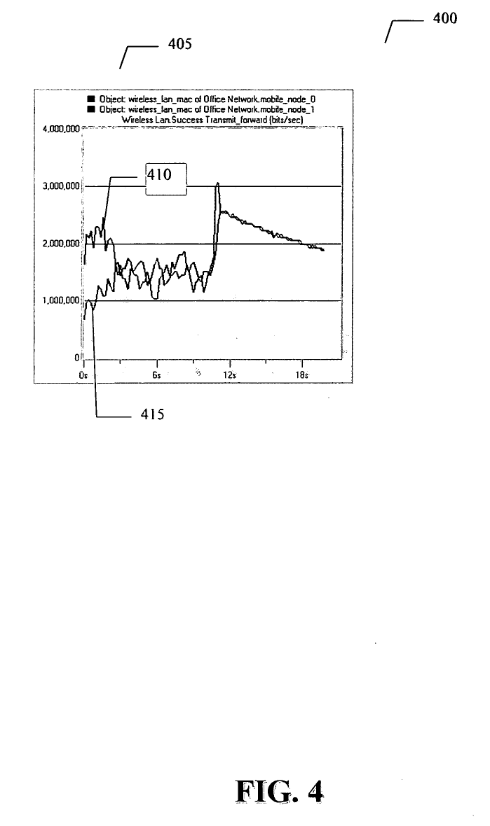

Turning now to FIG. 4 is illustrated graphically at 400 the throughput of the forward flow over two hops under the flow control mechanism which does not utilize channel idle time as a metric to avoid channel under-utilization. As it is shown in the graph, the throughput of forward flow temporarily increases as node 1 (415) exploits the sudden increase in the capacity to empty the packets that it already has in its queue. But after this transient behavior, contrary to the expectation that the forward flow should increase its rate to exploit the extra capacity in the system, the throughput of this flow decreases. The reason for this behavior is that without use of channel idle/busy time measurements, the intermediate node has no way of detecting the extra capacity and what an appropriate transmission rate for node 0 (410) should be.

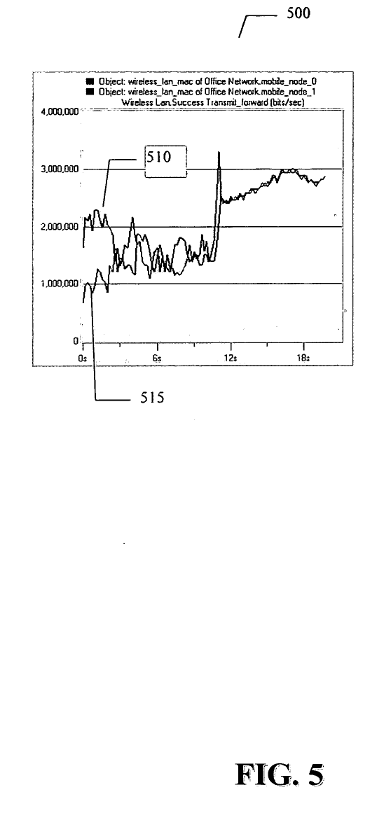

FIG. 5 shows graphically at 500 the network performance when channel idle/busy time measurement is being used in combination with a flow control mechanism. Here, after the extra capacity becomes available, node 1 (515) realizes that and feedbacks that information to node 0 (510), which increases its rate to the appropriate rate to fill up the channel.

An embodiment of the present invention further provides a method, comprising using a flow control technique in a distributed communication wireless network to notify traffic sources of transmission rates which would be appropriate for a given network state and to detect congestion and under utilization in said wireless network and increasing said traffic source's data rate upon detection of under utilization in said wireless network. Further, an embodiment of the present invention may provide a system, comprising a plurality of traffic sources in a distributed communication wireless network and wherein the plurality of traffic sources are capable of using a flow control technique to notify the traffic sources of transmission rates which would be appropriate for the distributed communication wireless network and to detect congestion and under utilization in the wireless network.

Yet another embodiment of the present invention may provide a machine-accessible medium that provides instructions, which when accessed, cause a machine to perform operations comprising using a flow control technique in a distributed communication wireless network to notify traffic sources of transmission rates which would be appropriate for a given network state and to detect congestion and under utilization in the wireless network and increasing said traffic source's data rate upon detection of under utilization in said wireless network. The flow control technique may include measurement of channel idle time as a metric to be used to detect under-utilization in the network as well as a technique to estimate the target transmission rate that can be handled by the network.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

1. An apparatus, comprising:
at least one node capable of communicating in a distributed communication wireless network; and
wherein said at least one node is capable of using a flow control technique to notify traffic sources of transmission rates which would be appropriate for a given network state and to detect congestion and under utilization in said wireless network.

2. The apparatus of claim 1, wherein said under utilization is caused by either removal of a source of congestion or addition of resources.

3. The apparatus of claim 2, wherein upon detection of under utilization in said wireless network, said node is capable of increasing its data rate.

4. The apparatus of claim 1, wherein said flow control technique includes measurement of channel idle time as a metric to be used to detect under-utilization in said network as well as a technique to estimate the target transmission rate that can be handled by said network.

5. The apparatus of claim 4, wherein said target transmission rate is used by upstream nodes to limit their transmission rate to an upper bound.

6. The apparatus of claim 1, wherein when said node accesses a channel of said distributed communication wireless network for transmission of a packet, said channel will be measured busy by all other nodes within interference range of said node for the duration of said packet transmission.

7. The apparatus of claim 6, wherein said node measures said channel busy and idle times in a contention region by use of a measurement window, Tₘₑₐₛᵤᵣₑₘₑₙₜ and wherein said all other nodes, if not transmitting, sense said channel regularly and are capable of measuring channel busy time, T_{busy}, over said measurement window Tₘₑₐₛᵤᵣₑₘₑₙₜ and wherein said channel idle time, T_{idle}, is then Tₘₑₐₛᵤᵣₑₘₑₙₜ−T_{busy}.

8. The apparatus of claim 7, wherein said channel is considered under-utilized if T_{idle}>I_{threshold}, where I_{threshold} is a pre-set threshold.

9. The apparatus of claim 8, wherein the T_{busy} to Tₘₑₐₛᵤᵣₑₘₑₙₜ ratio is set to approximately 70% for maximum channel utilization and the remaining 30% is used for backoffs and other silent periods.

10. A method, comprising:
using a flow control technique in a distributed communication wireless network to notify traffic sources of transmission rates which would be appropriate for a given network state and to detect congestion and under utilization in said wireless network; and
increasing said traffic source's data rate upon detection of under utilization in said wireless network.

11. The method of claim 10, wherein said under utilization is caused by either removal of a source of congestion or addition of resources.

12. The method of claim 10, further comprising including measurement of channel idle time as a metric to be used in said flow control technique to detect under-utilization in said network.

13. The method of claim 12, further comprising using a target transmission rate by upstream traffic sources to limit their transmission rate to an upper bound and hence avoid severe congestion.

14. The method of claim 10, further comprising accessing by said traffic source a channel of said distributed communication wireless network for transmission of a packet and wherein said channel will be measured busy by all other nodes within interference range of said node for the duration of said packet transmission.

15. The method of claim 14, wherein said node measures said channel busy and idle times in a contention region by use of a measurement window, Tₘₑₐₛᵤᵣₑₘₑₙₜ and wherein said all other nodes, if not transmitting, sense said channel regularly and are capable of measuring channel busy time, T_{busy}, over measurement window Tₘₑₐₛᵤᵣₑₘₑₙₜ and wherein said channel idle time, T_{idle}, is then Tₘₑₐₛᵤᵣₑₘₑₙₜ −T_{busy}.

16. The method of claim 15, wherein said channel is considered under-utilized if T_{idle}>I_{threshold}, where Ithreshold is a pre-set threshold.

17. The method of claim 16, wherein the T_{busy} to Tₘₑₐₛᵤᵣₑₘₑₙₜ ratio is set to approximately 70% for maximum channel utilization and the remaining 30% is used for backoffs and other silent periods.

18. A system, comprising:
a plurality of traffic sources in a distributed communication wireless network; and
wherein said plurality of traffic sources are capable of using a flow control technique to notify said traffic sources of transmission rates which would be appropriate for said distributed communication wireless network and to detect congestion and under utilization in said wireless network.

19. The system of claim 18, wherein upon detection of under utilization in said wireless network, at least one of said plurality of traffic sources is capable of increasing its data rate.

20. The system of claim 19, wherein said flow control technique includes measurement of channel idle time as a metric to be used to detect under-utilization in said network as well as a technique to estimate the target transmission rate that can be handled by said network.

21. The system of claim 20, wherein said target transmission rate is used by upstream nodes to limit their transmission rate to an upper bound and hence avoid severe congestion.

22. The system of claim 21, wherein said node measures said channel busy and idle times in its contention region by use of a measurement window, Tₘₑₐₛᵤᵣₑₘₑₙₜ and wherein said all other nodes, if not transmitting, sense said channel regularly and are capable of measuring channel busy time, T_{busy}, over measurement window Tₘₑₐₛᵤᵣₑₘₑₙₜ and wherein said channel idle time, T_{idle}, is then Tₘₑₐₛᵤᵣₑₘₑₙₜ −T_{busy}.

23. The system of claim 22, wherein said channel is considered under-utilized if T_{idle}>I_{threshold}, where I_{threshold} is a pre-set threshold.

24. A machine-accessible medium that provides instructions, which when accessed, cause a machine to perform operations comprising:
using a flow control technique in a distributed communication wireless network to notify traffic sources of transmission rates which would be appropriate for a given network state and to detect congestion and under utilization in said wireless network; and
increasing said traffic source's data rate upon detection of under utilization in said wireless network.

25. The machine-accessible medium that provides instructions of claim 24, wherein the instructions, when further accessed cause the machine to perform operations further comprising:
including measurement of channel idle time as a metric to be used in said flow control technique to detect under-utilization in said network.

26. The machine-accessible medium that provides instructions of claim 24, wherein the instructions, when further accessed cause the machine to perform operations further comprising:
using said target transmission rate by upstream traffic sources to limit their transmission rate to an upper bound and hence avoid severe congestion.

27. The machine-accessible medium that provides instructions of claim 24, wherein the instructions, when further accessed cause the machine to perform operations further comprising:
accessing by said traffic source a channel of said distributed communication wireless network for transmission of a packet and wherein said channel will be measured busy by all other nodes within interference range of said node for the duration of said packet transmission.

28. The machine-accessible medium that provides instructions of claim 24, wherein the instructions, when further accessed cause the machine to perform operations further comprising:
measuring said channel busy and idle times in its contention region by use of a measurement window, Tₘₑₐₛᵤᵣₑₘₑₙₜ and wherein said all other nodes, if not transmitting, sense said channel regularly and are capable of measuring channel busy time, T_{busy}, over measurement window Tₘₑₐₛᵤᵣₑₘₑₙₜ and wherein said channel idle time, T_{idle}, is then Tₘₑₐₛᵤᵣₑₘₑₙₜ−T_{busy}.

29. The machine-accessible medium that provides instructions of claim 28, wherein the instructions, when further accessed cause the machine to perform operations further comprising:
considering said channel to be under-utilized if T_{idle}>I_{threshold}, where I_{threshold} is a pre-set threshold.

30. The machine-accessible medium that provides instructions of claim 28, wherein the instructions, when further accessed cause the machine to perform operations further comprising, providing that the T_{busy} to Tₘₑₐₛᵤᵣₑₘₑₙₜ ratio is set to approximately 70% for maximum channel utilization and the remaining 30% is used for backoffs and other silent periods.
